(19) United States
(12) Patent Application Publication
(10) Pub. No.: US 2008/0161075 A1
(43) Pub. Date: Jul. 3, 2008

(54) Slide-Up Opening and Closing Mechanism For Portable Terminal

(75) Inventors: Si-Wan Kim, Gyeonggi-do (KR); Woong-Youl Kim, Gyeonggi-do (KR); Jun-Hong Lee, Gyeonggi-do (KR)

Correspondence Address: HARNESS, DICKEY, & PIERCE, P.L.C, 7700 Bonhomme, Suite 400, ST. LOUIS, MO, 63105, US

(73) Assignee: M2SYS CO., LTD., Bucheon-si, Gyeonggi-do (KR)

(21) Appl. No.: 12/065,279

(22) PCT Filed: Mar. 29, 2007
(86) PCT No.: PCT/KR07/01538

§ 371 Date: Feb. 28, 2008

(30) Foreign Application Priority Data
Apr. 4, 2006 (KR) KR10-2006-0030604
Apr. 4, 2006 (KR) KR10-2006-0030608
Aug. 18, 2006 (KR) KR10-2006-0078294

(51) Int. Cl. H04B 1/38

(52) U.S. Cl. 455/575.4

(57) ABSTRACT

Disclosed herein is a slide-up opening and closing apparatus for a communications terminal. The apparatus includes a slider unit, a slider assembly and an angular positioning member in order to open a slider body with respect to a main body. With the apparatus, the slider body can be opened with a desired inclination against the main body and after a certain degree of opening, automatically complete its opening operation without any further force or action, thereby providing a convenient use. In addition, the slider body can be opened with freedom without interference by the main body. Further, when the slider body is opened, most of the top face of the main body can be exposed, thereby providing a convenience of use.

### TECHNICAL FIELD

The present invention relates to a slide-up opening and closing mechanism for portable terminals, more specifically to such a slider mechanism capable of opening a slider body at a certain tilted angle with respect to a main body.

### BACKGROUND ART

Recently, communications terminal have been widely used through rapid advancement in the wireless information and communications technology. This communications terminal necessitates additional functions to user's taste, for example, in its opening and closing operation, together with its inherent function of wireless communication.

A communications terminal is categorized into a bar-type, a flip type and a folder type, etc.

Among these types of terminals, the folder type terminal and the slider type terminal have been extensively used, which can be fabricated in a slim form while having a display unit with a wide LCD module.

The slider type communications terminal is configured such that a slider body is slidably opened and closed with respect to a main body.

In a typical slider type communications terminal, the main body is provided with a guide groove, and the slider body is provided with a roller or sliding protrusion, which slidably moves along the guide groove. When the slider body is pushed in one direction, it moves straightly along the main body to open the terminal to be used. If the slider body is pushed back in the other direction from the open state, the slider body becomes closed on the main body.

In the conventional slider type communications terminal, however, the slider body is configured to open the terminal in a linear fashion, causing inconvenience when in use.

That is, the transmitter and receiver of the terminal can not be positioned near the user's mouth and ear respectively, thereby leading to inconvenience and degradation in the communication quality.

In addition, when a display unit or a touch screen is adopted in the slider type terminal, their use is not very convenient.

On the other hand, Korean Patent Application Laid-open No. 2005-0056609 discloses a “slide-up type portable terminal.”

Referring to FIGS. 38 and 39, the conventional portable terminal includes a main body 2, a slider body 4 moving along the main body 2 to open the terminal, and an angular positioning member 6 disposed between the main body 2 and the slider body 4. The angular positioning member 6 is configured to elevate one side of the slider body 4 when it is being opened.

The main body 2 is provided with a pair of slots 18 formed at both lateral sides of the upper portion thereof. Formed at both lateral side of the rear side of the slider body 4 is a slider pin 20 which moves along the slot 18.

Formed at both inner lateral sides of the main body 2 is a support shaft 28 serving as a hinge shaft. The slider body 4 is provided with a guide groove 32 formed at both inner lateral sides.

The angular positioning member 6 is composed of a main body 34, a pair of rotor tips 36 extended from both lateral sides of the lower end of the main body 34, and a guide pin 38 protruded from both lateral sides of the upper end portion of the main body 34.

The rotor tip 36 is rotatably connected to the support shaft 28 and the guide pin 38 is inserted into the guide groove 32 so as to slidably move along the groove.

In operation, when the slider body 4 is being opened, the guide pin 38 is stopped by the end portion of the guide groove 32 and thus the main body 34 is rotated about the rotor tip 36 such that the slider body 4 is opened in an angular or tilted fashion.

In the above slide-up type portable terminal, however, while opening of the slider body, movement of the angular positioning member along the guide groove may not be performed smoothly and also the user must forcibly push up until the slider body reaches a complete open position.

In addition, the end portion of the slider body may touch the main body when moving along with the slider pin, thereby not leading to a smooth opening operation. That is, since the slider body is being tilted while opening, the end portion of the slider body may press the main body to inhibit smooth movement of the slider body.

On the other hand, when a wide display unit is adopted, operation unit excepting the display is to be provided in the main body. In case of the above slide-up type portable terminal, however, the slider body has a limited opening distance and thus the operation unit is to be installed in a limited area of the main body. Thus, it incurs a difficulty in the manufacturing process or results in a smaller size of operation unit which leads to users inconvenience.

### DISCLOSURE OF INVENTION

### Technical Problem

The present invention has been made in order to solve at least part of the problems in the art. It is an object of the invention to provide a slide-up opening and closing apparatus for a communications terminal, in which a slider body can be opened with a desired inclination against a main body and after a certain degree of opening, automatically complete its opening operation without any further force or action, thereby providing a convenient use.

Another object of the invention is to provide a slide-up opening and closing apparatus for communications terminals, in which the slider body can be opened with freedom without interference by the main body.

A further object of the invention is to provide a slide-up opening and closing apparatus for communications terminal, in which most of the top face of the main body can be exposed when the slider body is opened, thereby providing a convenience of use.

### Technical Solution

In order to accomplish the above objects, according to one aspect of the invention, there is provided a slide-up opening and closing apparatus for a communications terminal, the communications terminal including a main body and a slider body slidably combined with the main body, the apparatus comprising: a pair of slider units provided in the main body; a slider assembly disposed between the main body and the slider body, the slider assembly moving along the slider unit such that the slider body is opened against the main body; an angular positioning member having a pivot rotatably combined to the main body and a rotor tip combined to the slider body, the rotor tip being turned about the pivot such that the slider body is opened in an inclined fashion; a click cam shaft fixed to the pivot of the angular positioning member, the angular positioning member having a protruded portion on the outer circumferential face thereof; and a resilient member configured such that at one point during rotation of the click cam shaft, the resilient member is maximally compressed by the protruded portion of the click cam shaft and then exerts the elastic restoring force on the click cam shaft to guide the click cam shaft to rotate in any one direction.

According to another aspect of the invention, there is provided a slide-up opening and closing apparatus for a communications terminal, the communications terminal including a main body and a slider body slidably combined with the main body, the apparatus comprising: a pair of slider units provided in the main body; a slider assembly disposed between the main body and the slider body, the slider assembly moving along the slider unit such that the slider body is opened against the main body; an angular positioning member having a hinge portion rotatably combined to the main body and a rotor tip combined to the slider body, the rotor tip being turned about the hinge portion such that the slider body is opened in an inclined fashion; a shaft cam for rotatably combining the hinge portion of the angular positioning member with the main body; a holder cam moving far away from and engaging again with the shaft cam along the axial direction while rotating with the hinge portion of the angular positioning member; and a resilient member configured such that when the holder cam moves away from the shaft cam, the resilient member is compressed and then exerts the elastic restoring force on the holder cam to guide the holder cam to rotate in any one direction.

According to another aspect of the invention, there is provided a slide-up opening and closing apparatus for a communications terminal having a first body and a second body, the apparatus comprising: a guide rail being fixed to the second body; a slider block guiding the guide rail so as to slidably move in a first direction; one or more balls installed in contact area between the slider block and the guide rail to reduce friction in-between; and a hinge portion being fixed to the first body and combining the slider block so as to enable to turn in a second direction, wherein the second body can be slidably opened in the first direction from the first body in parallel to each other and one end of the second body can be lift up from the first body to turn in the second direction.

### Advantageous Effects

According to the present invention, the slider body can be opened with a desired inclination against the main body and after a certain degree of opening, automatically complete its opening operation without any further force or action, thereby providing a convenient use.

In addition, the slider body can be opened with freedom without interference by the main body.

Further, when the slider body is opened, most of the top face of the main body can be exposed, thereby providing a convenience of use.

### BRIEF DESCRIPTION OF THE DRAWINGS

Further objects and advantages of the invention can be more fully understood from the following detailed description taken in conjunction with the accompanying drawings in which:

FIG. 1 is perspective views of a communications terminal according to the first embodiment of the invention where FIG. 1(a) shows a closed state of the terminal, FIG. 1(b) shows an intermediate state of opening procedure and FIG. 1(c) shows a complete open state of the terminal;

FIG. 2 is side views corresponding to FIGS. 1(a), (b) and (c) respectively;

FIG. 3 is a sectional view of FIG. 2(a);

FIG. 4 is a sectional view of FIG. 2(b);

FIG. 5 is a sectional view of FIG. 2(c);

FIG. 6 is an exploded perspective view of the communications terminal according to the first embodiment;

FIG. 7 is a perspective view of a slide-up opening and closing apparatus for a communications terminal, according to the first embodiment of the invention;

FIG. 8 is an exploded perspective view of the slider member in FIG. 7;

FIG. 9 is a perspective view of the main body in a communications terminal according to the first embodiment of the invention;

FIG. 10 shows the main body of FIG. 9 from which the slider assembly is removed;

FIG. 11 is a perspective view of the main body, when seen from the bottom side, in a communications terminal according to the first embodiment of the invention;

FIG. 12 shows the main body of FIG. 11 from which the slider member is disassembled;

FIG. 13 is a perspective view of the slider body with an angular positioning member, when seen from the bottom side, in a communications terminal according to the first embodiment of the invention;

FIG. 14 shows the slider body of FIG. 13 from which the angular positioning member is disassembled;

FIG. 15 is perspective views of a communications terminal according to the second embodiment of the invention where FIG. 15(a) shows a closed state of the terminal and FIG. 15(b) shows a complete open state of the terminal;

FIG. 16 is sectional views of the communications terminal of FIG. 15 where FIG. 16(a) shows a closed state of the terminal, FIG. 16(b) shows an intermediate state of opening procedure and FIG. 16(c) shows a complete open state of the terminal;

FIG. 17 is a sectional view of FIG. 16(a);

FIG. 18 is a sectional view of FIG. 16(b);

FIG. 19 is a sectional view of FIG. 16(c);

FIGS. 20 and 21 are exploded perspective view of the communications terminal according to the second embodiment of the invention;

FIG. 22 shows the angular positioning member in FIGS. 20 and 21;

FIG. 23 shows the slider assembly in FIGS. 20 and 21;

FIG. 24 is a perspective view of a communications terminal according to the third embodiment of the invention;

FIG. 25 is an exploded perspective view of the opening and closing apparatus in FIG. 24;

FIG. 26 is an exploded perspective view of the clutch means in FIG. 25;

FIG. 27 is a partial perspective view of the communications terminal of FIG. 24;

FIG. 28 shows the assembled state of the communications terminal of FIG. 24;

FIG. 29 is a perspective view of the opening and closing apparatus in the communications terminal of FIG. 25;

FIG. 30 shows the communications terminal of FIG. 25 where the second body is partially opened towards a first direction;

FIG. 31 is a perspective view of the opening and closing apparatus in the communications terminal of FIG. 30;

FIG. 32 shows the communications terminal of FIG. 30 wherein the second body is completely opened towards a first direction;

FIG. 33 is a perspective view of the opening and closing apparatus in the communications terminal of FIG. 32;

FIG. 34 shows the communications terminal of FIG. 32 where the second body is partially rotated towards a second direction;

FIG. 35 is a perspective view of the opening and closing apparatus in the communications terminal of FIG. 34;

FIG. 36 shows the communications terminal of FIG. 34 where the second body is completely rotated towards the second direction;

FIG. 37 is a perspective view of the opening and closing apparatus in the communications terminal of FIG. 36; and

FIGS. 37 and 38 show a conventional communications terminal.

### MODE FOR THE INVENTION

Hereafter, exemplary embodiments according to the invention will be explained with reference to the accompanying drawings.

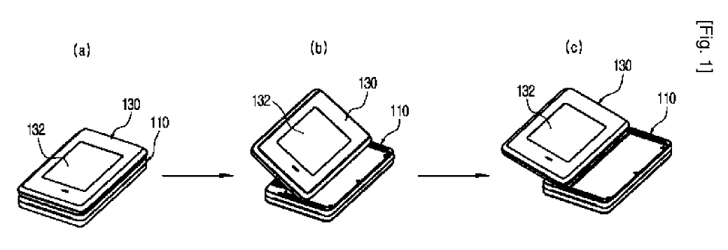

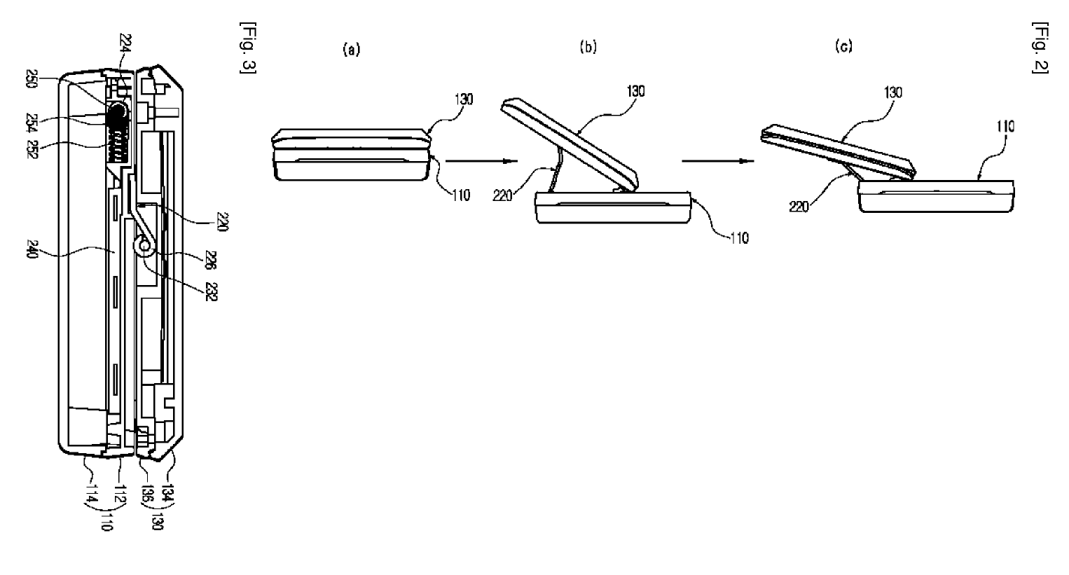

FIGS. 1 and 2 schematically show a communications terminal according to the first embodiment of the invention and the opening operation thereof.

Referring to FIGS. 1 and 2, the communications terminal includes a main body 110, a slider body 130 configured to slidably move along the main body 110, and an angular positioning member 220 disposed between the main body 110 and the slider body 130. The angular positioning member 220 is configured such that, when the slider body 130 is being opening, the slider body 130 and the main body 110 are positioned at a certain angle with respect to each other.

The main body 110 may be provided with an input means for inputting information such as numerals and characters, and the slider body 130 may be provided with a display unit 132 for outputting information.

As shown in FIGS. 1(a) and 2(a), when the communications terminal is closed, the slider body 130 rests on top of the main body 110.

Referring to FIGS. 1(b) and 2(b), while opening the terminal, the slider body 130 slidably moves on the main body 110 and tilted at an angle by means of the angular positioning member 220. The slider body 130 takes a maximum angular position with respect to the main body 110 when it is opened midway, i.e., roughly at the intermediate state.

As can be seen from FIG. 1(c) and FIG. 2 (c), when the slider body 130 is completely opened, the front face of the main body 110 is exposed almost in its entirety. At this time, the slider body 130 remains inclined at a certain angle with respect to the main body 110 by means of the angular positioning member 220. The inclination angle at the completely open state is smaller than at the intermediately open state.

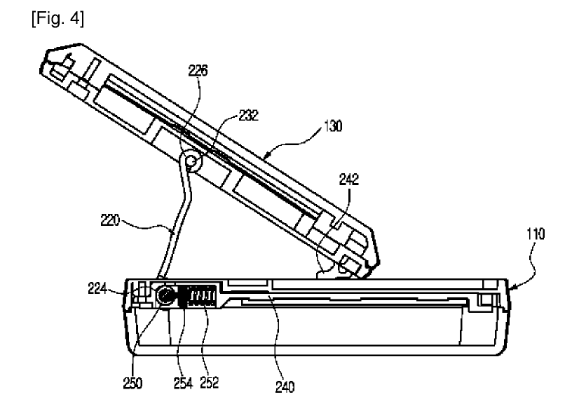

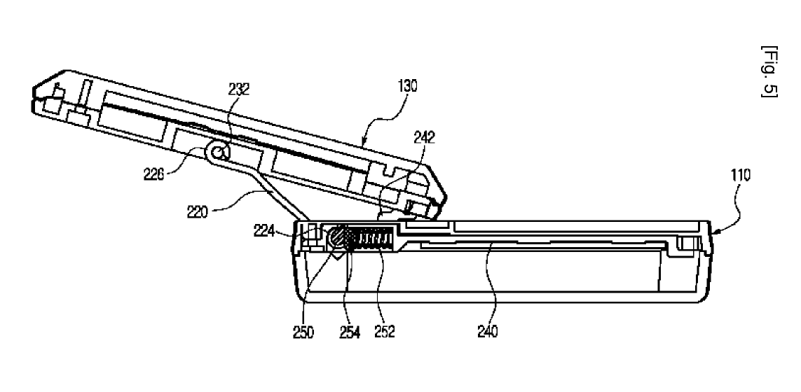

FIGS. 3 to 5 are sectional view showing the opening operation of the communications terminal.

The main body 110 may be provided at its top cover 112 with an input means for information, and at its bottom cover 114 with a battery.

Typically the slider body 130 is provided at its top cover with a display unit and at its bottom cover with assembling parts.

The main body 110 and the slider body 130 are interconnected through an electric wire. In order to open the slider body 130, a slider unit 240, a slider assembly and an angular positioning member 220 are provided.

Secured to one end of the slider body 130 is a slider 242, which slides along the slider unit 240. Typically, if the slider body 130 is opened backward from the front side, the slider 242 is disposed forward of the angular positioning member 220.

One end of the slider 242 is inserted into a guide groove 245 (refer to FIG. 7) provided on top of the slider unit 240, and the other end of the slider 242 is fixed to the slider body 130. The slider 242 moves along the slider unit 240 to open and close the slider body 130.

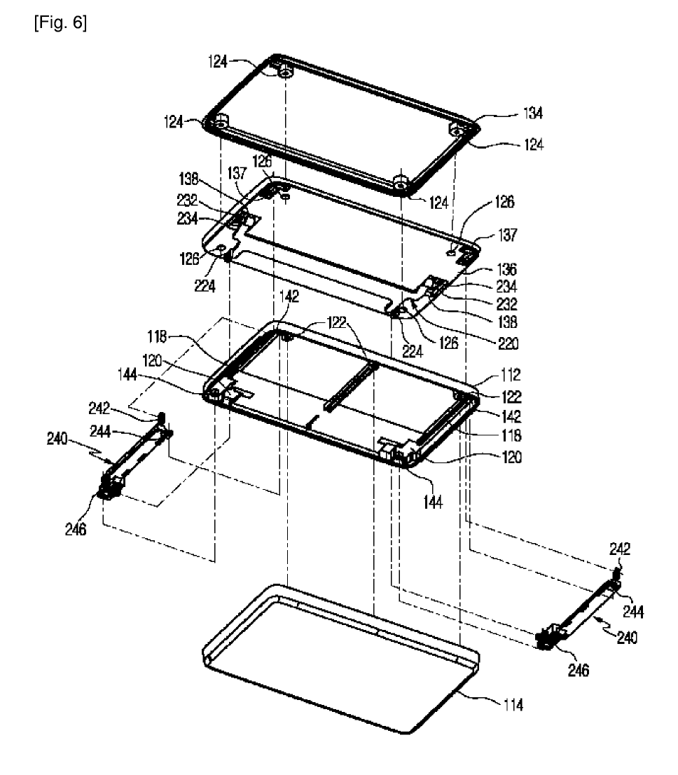

One end of the angular positioning member 220 is a rotor tip 226, which is rotatably secured to both lateral sides of the central area of the slider body 130. The rotor tip 226 is rotatably connected to a fixed shaft 232. The fixing shaft 232 is secured to both lateral sides of the central area of the bottom cover of the slider body 130, by means of a bracket 234 (in FIG. 6).

The other end of the angular positioning member 220 is a pivot 224, which is rotatably installed at the rear end of the top cover 112 of the main body. The pivot 224 is fixed to a click cam shaft 250. The click cam shaft 250 is installed in a cam receptacle 246 of the slider unit 240 (refer to FIG. 6). The slider unit 240 is installed inside of the top cover 112 of the main body 110.

The outer circumferential face of the click cam shaft 250 protrudes to one side so as to provide an asymmetrical cross-section. The cam receptacle 246 is provided with a holder 254 installed so as to contact with the outer circumferential face of the click cam shaft 250. The holder 254 is resiliently supported by a resilient member 252.

In order to open the slider body 130 from the main body 110, when the user pushes the slider body 130 to move the slider 242, the rotor tip 228 of the angular positioning member 220 lifts up from the main body 110 while rotating. As the rotor tip 226 lifts up, the slider body 130 is opened assuming a certain inclination angle with respect to the main body 110.

During this course of action, the click cam shaft 250 rotates. When the slider body 130 is opened around halfway, the protruded portion of the click cam shaft 250 presses the holder 254, which in turn compresses the resilient member 252.

At this time, due to the elastic restoring force of the resilient member 252, the click cam shaft 250 rotates in the advancing forward direction and thus the slider body 130 is automatically opened, without necessitating the user's further action.

On the other hand, during the course of opening the slider body 130, the front end of the slider body 130 travels smoothly without interference by the main body 110. This is because the slider 242 is installed so as to provide a space enough for the front end of the slider body to move up and down. That is, although the front end of the slider body 130 is tilted while slidably moving, it does not touch the main body 110.

FIG. 6 is an exploded perspective view seen from the bottom side of the communications terminal.

The slider unit 240 is inserted inside of the top cover of the main body 110. The bottom cover 114 is assembled into the top cover 112. Provided at both sides of the bottom face of the top cover 112 is a slider receptacle 120, in which the slider unit 240 is installed. The slider receptacle 120 is provided with a slider groove 118. According to the opening direction of the slider body 130, the cam receptacle 246 of the slider unit 240 is disposed at the rear side of the main body 110. The cam receptacle 246 is secured to a first fixing hole 144 of the top cover 112 by means of a fastener means. The other end of the slider unit 240 is secured to a second fixing hole 142. The top cover 112 is provided with a plurality of connection holes 122 into which fastener means are inserted to assemble the bottom cover 114.

The angular positioning member 220 is installed between the top cover of the main body 110 and the bottom cover 136 of the slider body 130. Formed at both sides of the central area of the bottom cover 136 of the slider body 130 is a bracket fixing portion 138. Formed at the front edge of the bottom cover 136 is a slider housing fixing portion 137. The top cover 134 is assembled on top of the bottom cover 136. The top cover 134 is provided at the four corners of the bottom face thereof with protrusions 124 to which the fastener means is assembled. Corresponding to this, a connection hole 126 is provided at the four comers respectively of the bottom cover 136.

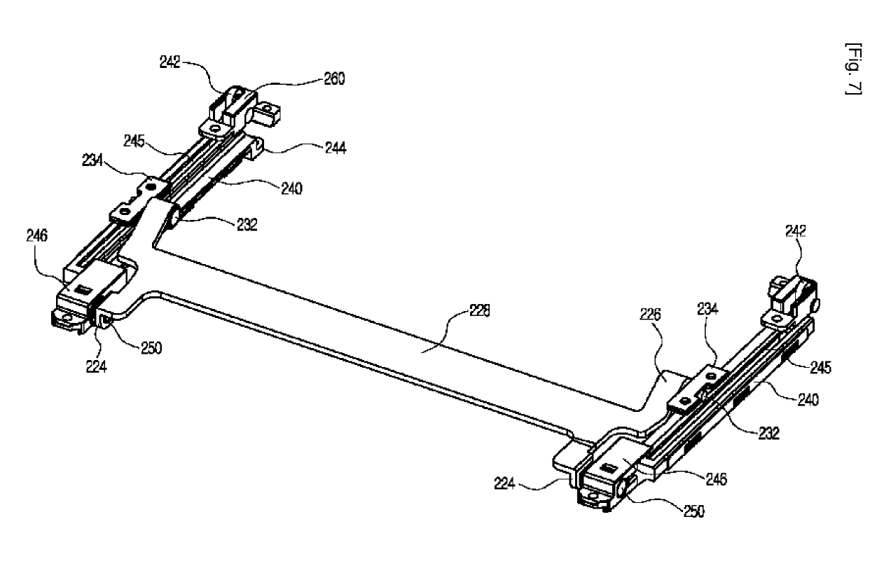

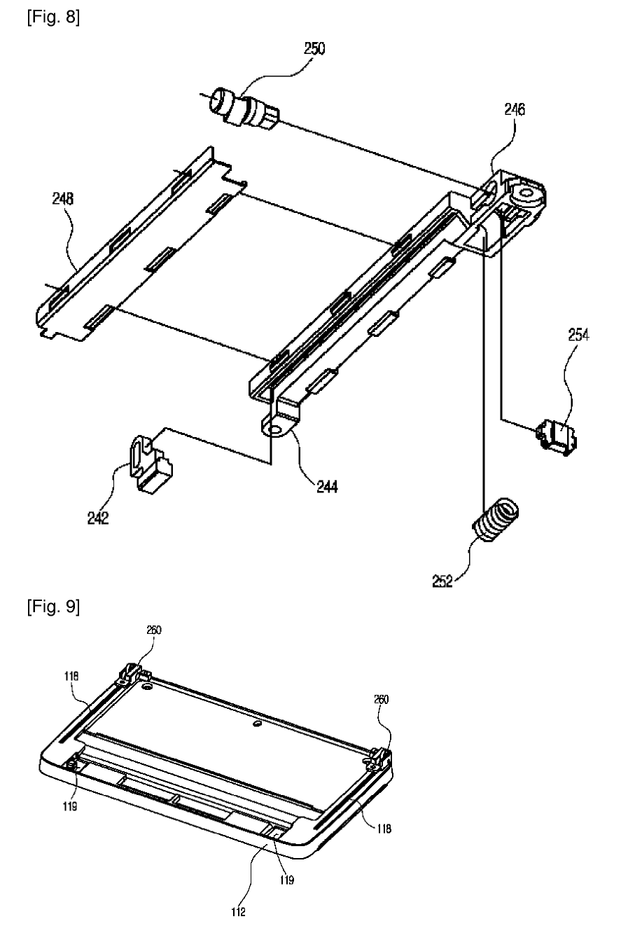

FIG. 7 shows a slide-up opening and closing apparatus according to the first embodiment of the invention. FIG. 8 shows a slider unit 240, which is part of the slide-up opening and closing apparatus of FIG. 7.

The slide-up opening and closing apparatus includes a slider unit 240, a slider assembly and an angular positioning member 220.

A cam receptacle 246 is provided at one end of the slider unit 240 and the angular positioning member 220 is fixed to the outside of the cam receptacle 246. A fixing portion 244 is formed at the other end of the slider unit 240. On top of the fixing portion 244, i.e., at the opposite side to the cam receptacle 246, a slider assembly is movably installed. A cover 248 is assembled into the body of the slider unit 240 and a guide groove 245 is formed on top of the slider unit 240.

The click cam shaft 250 is installed in such a way to get through the cam receptacle 246. Inside of the cam receptacle 246, a holder 254 is installed so as to support the outer circumferential face of the click cam shaft 250 and a resilient member 252 is installed to resiliently support the holder 254.

The slider assembly includes a slider 242 and a slider housing 260. One end of the slider 242 is inserted into the guide groove 245 of the slider unit 240 so as to enable to move along the guide groove 245. The slider 242 is fixed to the front end of the slider body 130 by means of the slider housing 260. The slider housing 260 is installed rotatably and movable up and down with respect to the slider 242.

The angular positioning member 220 includes a body portion 228. A pivot 224 is extended in one direction from both ends of the body portion 228 and fixed to the outside of the cam receptacle 246 of the slider unit 240 through the click cam shaft 250. A rotor tip 226 is extended in the opposite direction to the pivot 224. The rotor tip is configured to be turned about the pivot 224. A fixing shaft 232 is inserted into the rotor tip 226, which is secured to the slider body 130 by means of a bracket 234.

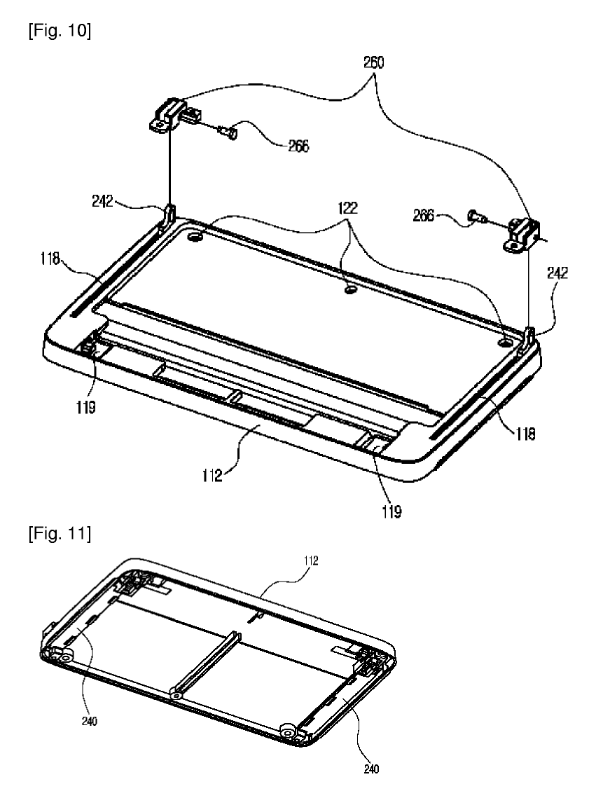

FIGS. 9 to 12 show the main body of the communications terminal.

A slider groove 118 is formed at both sides of the top cover 112 of the main body 110. The slider 242 is inserted into the slider groove 118. The slider 242 is assembled into the slider housing 260 by means of a fixing pin 266. The fixing pin 266 is configured so as to move up and down along the elongated hole formed in the body of the slider 242.

At the rear end portion of the top cover 112 of the main body 110 is provided a pivot receptacle 119 for accommodating the pivot 224 of the angular positioning member 220. At both sides of the bottom face of the top cover 112 is provided a slider receptacle 120. The slider unit 240 is received and installed in the slider receptacle 120. The top face of the slider unit 240 contacts the slider groove 118.

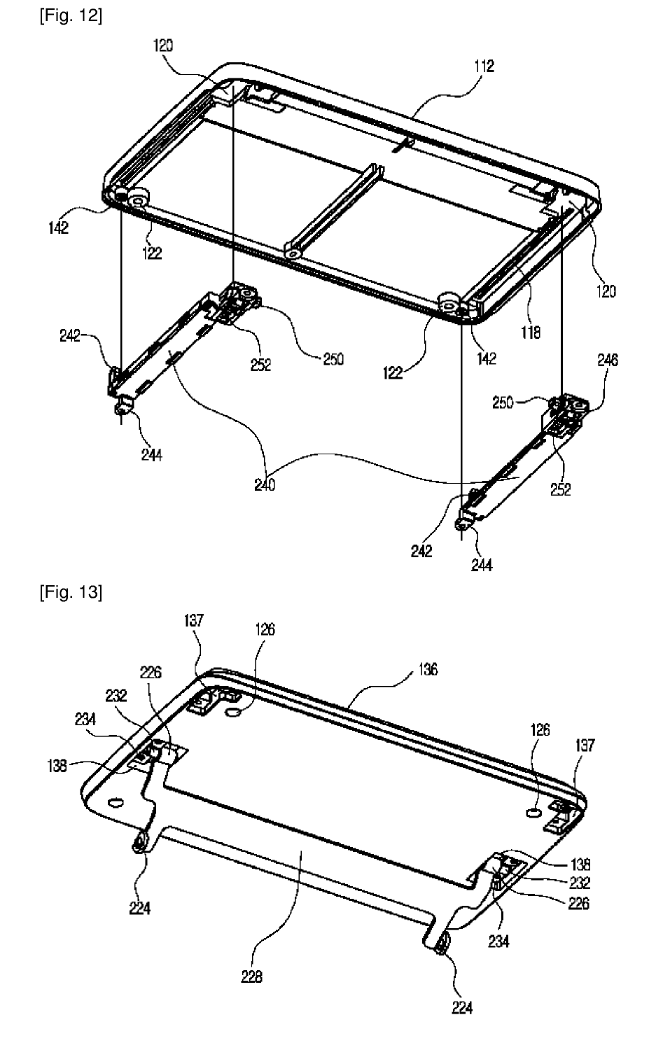

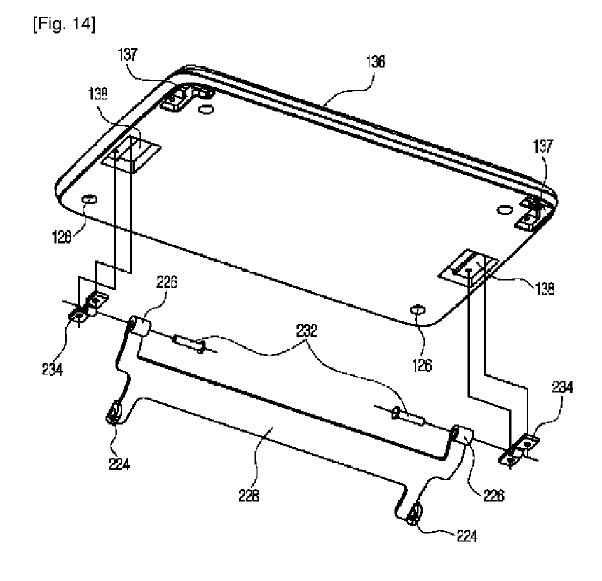

FIGS. 13 and 14 show the slider body 130 of the communications terminal.

The slider body 130 is provided with a bracket fixing portion 138 formed at both sides of the bottom face of the bottom cover 136. A bracket 234 is fixed to the bracket fixing portion 138. The rotor tip 226 of the angular positioning member 220 is rotatably assembled into the bracket 234 through the fixing shaft 232. At the front edge of the bottom face of the bottom cover 136 is formed a slider housing fixing portion 137.

The operation of the above-configured slide-up opening and closing apparatus is explained hereafter.

If a user exerts a force on the slider body 130 in order to open it, the slider 242 disposed in the front end of the slider body 130 moves towards the cam receptacle 246 along the guide groove of the slider unit 130. At this time, the rotor top 226, which is installed at both central end portions of the slider body 130, lifts up backwards. Then, the slider body 130 is being opened with respect to the main body 110 while being inclined at a certain angle. The rotor tip 226 of the angular positioning member 220 turns about the pivot 224, which depends on rotation of the click cam shaft 250. When the slider body 130 is roughly halfway opened, the rotor tip 226 is placed at the highest point. At this time, the protruded portion on the outer circumferential face of the click cam shaft 250 presses the resilient member 252. Accordingly, the elastic restoring force of the resilient member 252 is exerted on the click cam shaft 250 so that rotation of the click cam shaft 250 is accelerated towards the direction in which it was being rotated. Thus, after the slider body 130 has been opened roughly halfway, it can be automatically opened, without the user's further force.

Closing of the slider body 130 is performed in reverse orders of the above opening operation. If the user exerts a force on the slider body 130 in order to close it, the slider 130 moves frontward of the main body 110. Thus, the rotor tip 226 lifts up towards the front side. Similarly, as the rotor tip 226 passes the highest point, the click cam shaft 250 comes to rotate in its advancing direction. Accordingly, the angular positioning member 220 rotates in the forward direction and thus the slider body 130 comes to be automatically closed, without necessitating a further force by the user.

On the other hand, the slider housing 260 is assembled to enable to rotate and move up and down with respect to the slider 242. Therefore, when the slider body 130 is being opened, the end portion of the slider body 130 can slide smoothly without interference to the main body 110.

Hereafter, the second embodiment of the invention will be explained in details, with reference to the accompanying drawings.

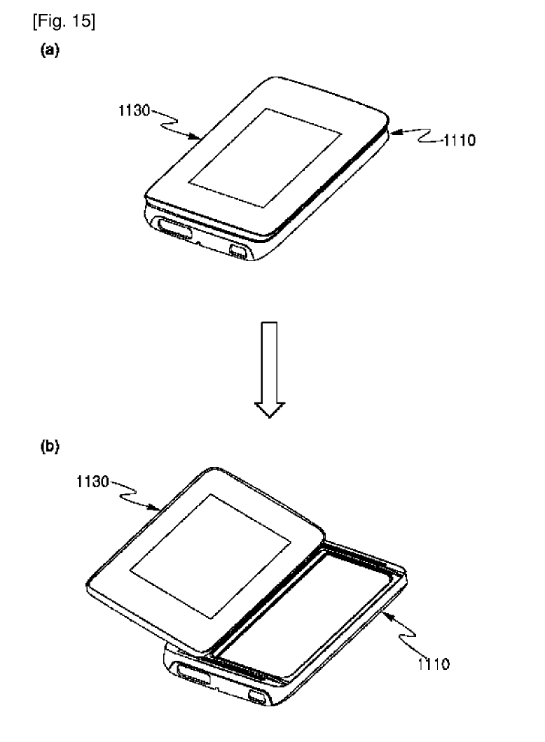

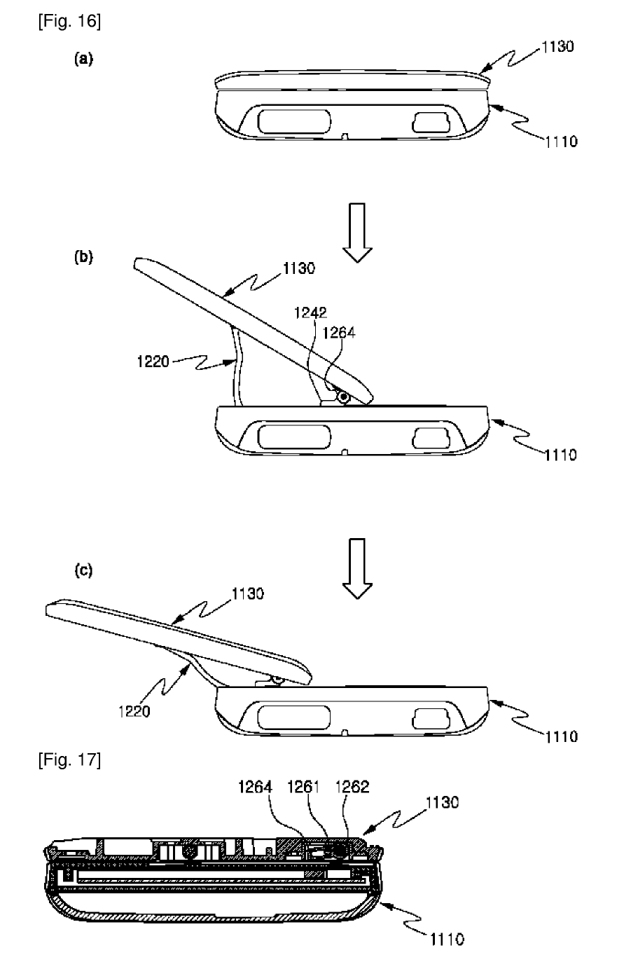

FIGS. 15 and 16 illustrate a communications terminal according to the second embodiment of the invention and the schematic operation of opening the terminal.

Referring to FIGS. 15 and 16, the communications terminal includes a main body 1110 and a slider body 1130 installed so as to slidably move along the main body 1110.

Between the main body 1110 and the slider body 1130 are provided a slider assembly for slidably moving the slider body 1130 against the main body 1110, and an angular positioning member 1220 for holding the slider body 1130 at a certain angular position with respect to the main body 110 when the slider body 1130 is open.

The slider assembly includes a slider arm 1264 attached to one end of the slider body 1130, and a slider 1242 assembled into the slider arm 1264 so as to be capable of sliding along the top face of the main body 1110.

The main body 1110 may be provided with a means for inputting information such as numerals or characters. The slider body 1130 may be provided with a display unit 1132 for displaying information.

As shown in FIG. 15(a) and FIG. 16(a), when the terminal is closed, the slider body 1130 remains on top of the main body 1110.

As shown in FIG. 15(b) and FIGS. 16(b) and (c), if the slider body 1130 is opened, the slider body 1130 becomes inclined at a certain angle against the main body 110 while sliding on the main body 1110. As shown in FIG. 16(b), the slider body 1130 becomes inclined with a maximum angle when it is roughly halfway opened.

When the slider body 1130 is completely opened, it comes to expose mostly the top face of the main body 1110, as shown in FIG. 16(c).

The inclination angle at the complete open state is smaller than at the halfway open state.

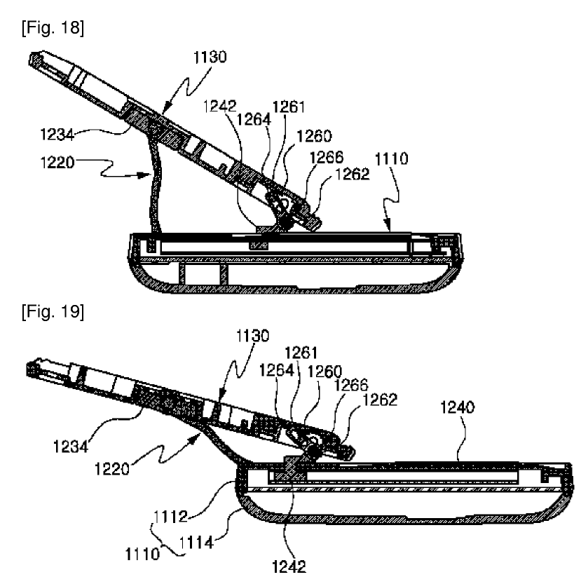

Referring to FIGS. 17 to 19, opening operation of the communications terminal is explained.

The main body 1110 includes a top cover 1112 having an information input means and a bottom cover 1114 in which a battery can be installed.

The main body 1110 and the slider body 1130 are interconnected through an electric wire. In order to open the slider body 1130 against the main body 1110, a slider unit 1240, a slider assembly and an angular positioning member 1220 are provided.

A slider housing 1260 is fixed to the slider body 1130. The slider housing 1260 is provided with a protrusion 1261, to which one end of a slider arm 1264 is rotatably assembled. Formed in the body of the slider arm 1264 is an elongated hole 1265, into which the protrusion 1261 is inserted. Thus, the slider housing 1260 is configured so as to be movable along the elongated hole 1265 of the slider arm 1264.

The other end of the slider arm 1264 is rotatably assembled into one end of the slider 1242 by means of a fixing pin 1266.

A torsion spring 1262 is inserted between the slider arm 1264 and the slider 1242. The slider arm 1264 is forced to place close to the slider 1242 by means of pulling force of the torsion spring 1262.

When the slider body is being opened in an inclined fashion, the slider arm 1264 becomes to place at a higher position than the end of the slider body 1130. If the slider housing 1260 is pulled towards the main body 1110, the end of the slider body 1130 lifts up and thus enables to slidably move without contact to the main body 1110.

One end of the angular positioning member 1220 is rotatably connected to both lateral sides of the central portion of the slider body 1130 and the other end thereof is rotatably connected to the rear side of the main body 1110.

Typically, assuming that the slider body 1130 is opened rearwards from the front side, the slider assembly is disposed frontward of the angular positioning member 1220.

Hereafter, opening operation of the slider body 1130 against the main body 1110 will be explained, with reference to the accompanying drawings.

If the user pushes the slider body 1130, the slider 1242 slides on the main body 1110 along the slider unit 1240, and simultaneously the angular positioning member 1220 lifts up and turns.

As the angular positioning member 1220 lifts up, the slider body 1130 becomes to be opened against the main body 1110 while being inclined at a certain inclination angle.

As can be seen from the turning path of the angular positioning member, during this course of operations, when the angular positioning member 1220 takes its highest position, the inclination angle becomes to maximum. At this point, the slider body 1130 becomes opened roughly halfway.

On the other hand, while the slider body 1130 is being opened, the front end of the slider body 1130 can perform a sooth sliding motion without interference with the main body 1110. This is because the slider assembly is structured and installed to provide a space for allowing an up-and-down movement of the front end of the slider body 1130.

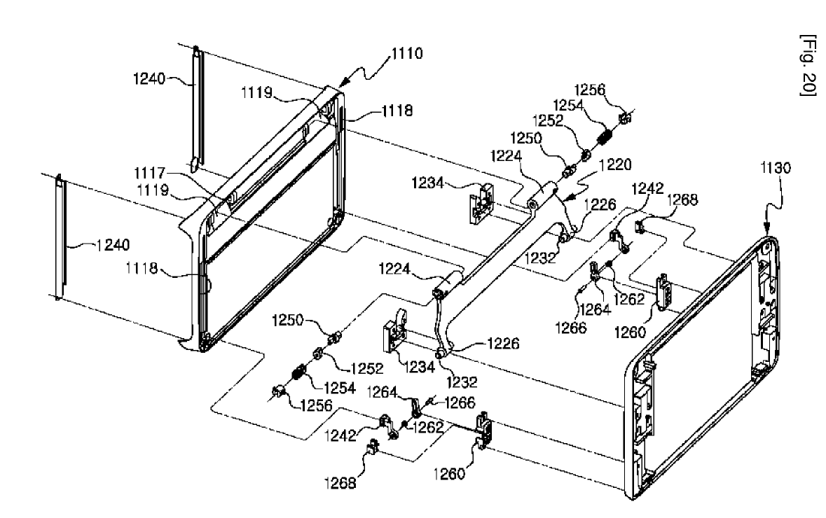

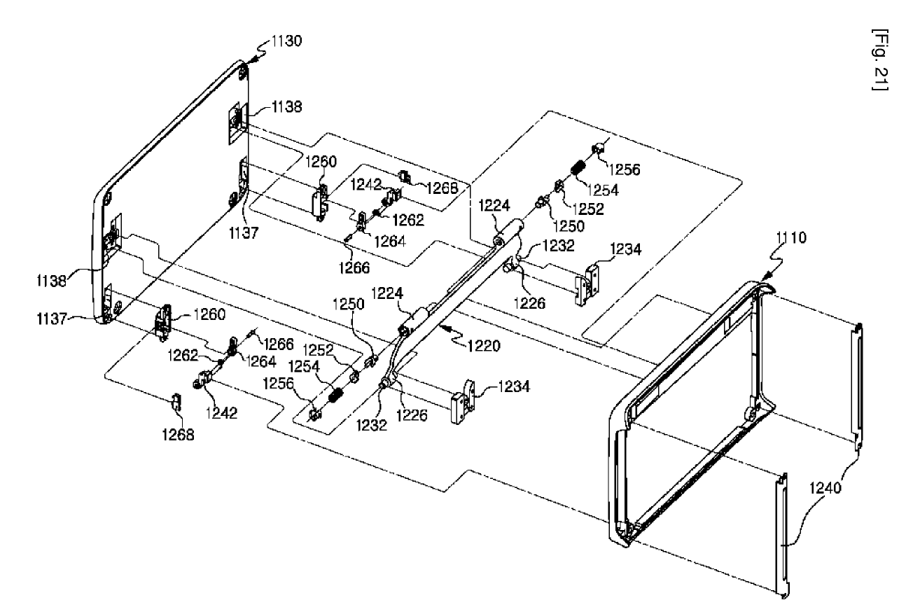

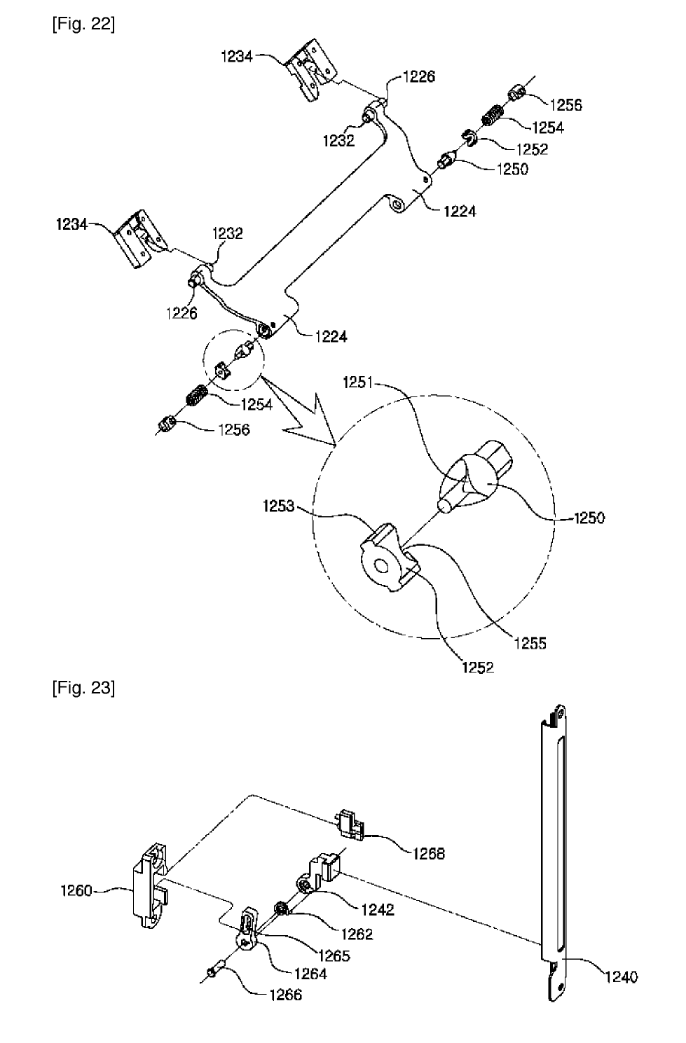

FIGS. 20 and 21 are exploded perspective views of the slide-up opening and closing apparatus. FIGS. 22 and 23 are exploded perspective views of the angular positioning member 1220 and the slider assembly respectively.

Referring to FIGS. 20 to 23, the assembled structure of the slide-up opening and closing apparatus will be explained.

The slider unit 1240 is combined to both lateral sides of the rear portion of the main body 1110. The angular positioning member 1220 is disposed at the front side of the main body 1110. The hinge portion 1224 of the angular positioning member 1220 is combined to a hinge receptacle 1119 of the main body 1110. First, a shaft cam 1250 is inserted into the hinge portion 1224. One end of the shaft cam 1250 passes through the hinge portion 1224 and inserted into a hinge connection hole 1250 of the hinge receptacle 1119 such that the hinge portion 1224 is rotatably secured to the main body 1110. That is, the shaft cam 1250 is a rotational shaft that is fixed to the main body 1110 regardless of rotation of the hinge portion 1224. Next, a holder cam 1252 is inserted into the hinge portion 1224. The holder cam 1252 is combined with the hinge portion 1224 so as not to rotate inside of the hinge portion by means of a protrusion 1253 formed on the outer face of the holder cam 1252. The holder cam 1252 is a rotor that rotates along with the hinge portion 1224. The holder cam 1252 is rotatably coupled with the other end of the shaft cam 1250. The contact faces between the shaft cam 1250 and the holder cam 1252 are formed of a waveform face 1251, 1255 having two periods per rotation. When the communications terminal remains closed, the shaft cam 1250 and the holder cam 1252 are face-contacted with each other. Conversely, while the communications terminal is being opened, the holder cam 1252 and the shaft cam 1250 move far away from each other. A resilient member 1254 is inserted next to the holder cam 1252 and then finally a hinge cover 1256 is inserted to close the hinge portion 1224.

The rotor tip 1226 of the angular positioning member 1220 is connected to both lateral sides of the central portion of the slider body 1130. The rotor tip 1226 is structured in a way to wrap around a fixing shaft 1232 so as to enable to rotate about the fixing shaft 1232. The fixing shaft 1232 is combined with a bracket 1234, which in turn is secured to a bracket fixing portion 1138 of the slider body 1130.

One end of the slider 1242 passes through the slide groove 1118 of the main body 1110 and is inserted into the slider unit 1240. The slider arm 1254 is assembled to the other end of the slider 1242 by means of a fixing pin 1266. The torsion spring 1262 is inserted between the slider 1242 and the slider arm 1264. The slider assembly assembled as above is combined to a slider housing fixing portion 1137 of the slider body 1130 by means of the slider housing 1260 and a slider cover 1268.

Operation of the above-constructed slide-up opening and closing apparatus will be explained hereafter.

First, in FIGS. 15 to 19, the left and right side of the figures is referred to as the “rear side” and “front side” respectively, with reference to the opening direction of the communications terminal.

If the user pushes the slider body 1130 backwards in order to open it, the slider 1242, attached to the front end of the slider body 1130, moves backwards along the slider unit 1240. At this time, the rotor tip 1226 of the angular positioning member 1220, attached to both lateral sides of the central portion of the slider body 1130, turns backwards. Then, the slider body 1130 becomes opened with a certain desired inclination to the main body 1110.

During this course of actions, as the rotor tip 1228 turns backwards, the hinge portion 1224 rotates. At this time, the holder cam 1252 inserted into the hinge portion 1224 rotates against the shaft cam 1250. Accordingly, the protruded portion in the waveform face 1255 of the holder cam 1252 interact the protruded portion so as to move far away from each other. Thus, the resilient member 1254 is compressed, and the compressed resilient member 1254 in turn pushes the holder cam 1252 back again towards the shaft cam 1250. When the holder cam 1252 and the shaft cam 1250 are in the maximum distance, i.e., when the resilient member 1254 is maximally compressed, the communications terminal is made opened roughly halfway. Thereafter, due to the elastic restoring force of the resilient member 1254, the holder cam 1252 further rotates in the advancing direction to thereby be engaged with the shaft cam 1250 again. In this way, after the slider body 1130 is opened halfway, the remaining opening procedure is automatically completed, without any further force from the user.

On the other hand, closing operation of the slider body 1130 can be performed in reverse orders to the above operations. If the user exerts a force on the slider body 1130 in the frontward direction in order to close it, the slider 1130 moves towards the front side of the main body 1110. Accordingly, the rotor tip 1226 turns towards the front side and then the slider body 1130 closes on the main body 1110.

Similarly, during the closing operation of the communications terminal, the holder cam 1252 rotates to be far away from the shaft cam 1250 and then engaged again with the shaft cam 1250 due to the elastic restoring force of the resilient member 1254, thereby automatically closing the terminal after the slider body 1130 is halfway closed.

On the other hand, when the communications terminal remains closed, the slider arm 1264 pulls the slider body 1130 towards the main body 1110, so that the slider body 1130 remains overlapped on top of the main body 1110 in a stable manner. When the communications terminal is being opened, the slider arm 1264 lifts up from the main body 1110 while the slider body 1130 is being opened and inclined. During this action, the slider arm 1264 receives tensions towards the main body 1110 by means of the torsion spring 1262. Thus, the end portion of slider body 1130 lifts up during the opening process and thus slidably moves without contact with the main body 1110.

Hereafter, a communications terminal according to the third embodiment of the invention will be explained.

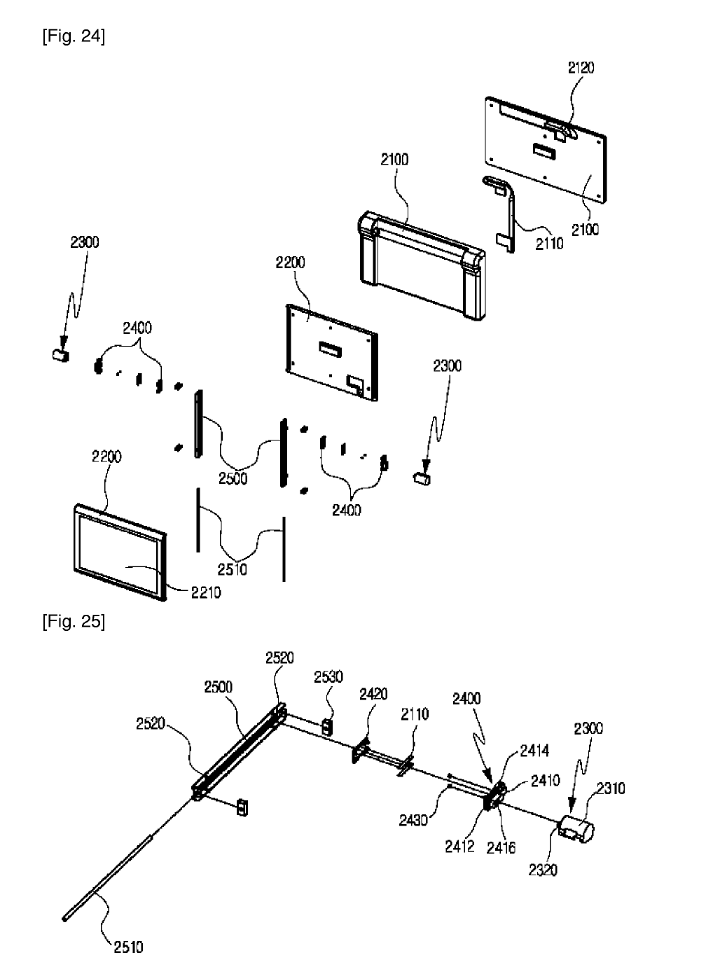

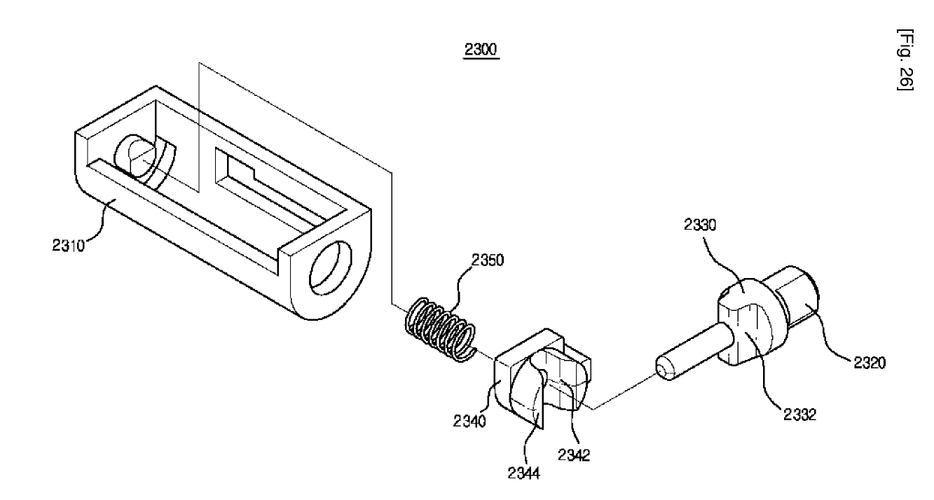

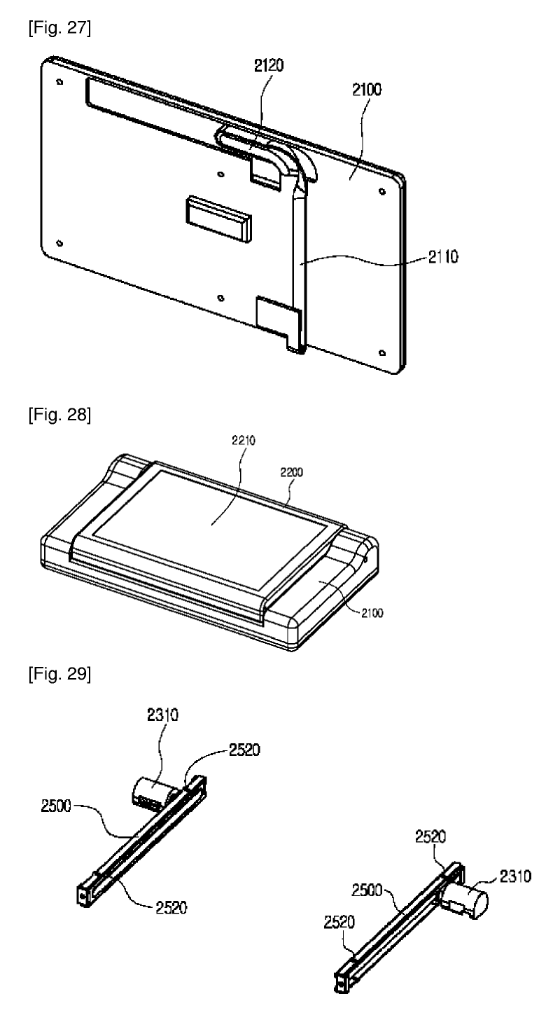

FIG. 24 is an exploded perspective view of a communications terminal according to the third embodiment of the invention. FIG. 25 is an exploded perspective view of the opening and closing apparatus in FIG. 24. FIG. 26 is an exploded perspective view of the clutch means in FIG. 25. FIG. 27 is a perspective view of part of the communications terminal in FIG. 24. FIG. 28 shows the assembled state of the communications terminal of FIG. 25.

The communications terminal includes a first body 2100 and a second body 2200. The first body forms the main body of the terminal. Inside of the first body 2100 are housed a circuit board, a chip and the like. Installed on top of the first body 2100 are various keypads for controlling functions of the main body.

On the top face of the second body 2200 is installed a liquid crystal window 2210 for displaying output signals from the first body 2100.

The slide-up opening and closing apparatus installed in the communications terminal is configured such that the second body 2200 can be slidably opened and closed in a first direction with respect to the first body 2100 and also one end of the second body 2200 can be turned up in a second direction from the first body 2100.

The slide-up opening and closing apparatus includes a guide rail 2500 fixed to the second body 2200, a slider block 2400 for guiding the guide rail 2500 to be slid in the first direction, and a hinge portion 2300 fixed to the first body 2100 and combining the slider block 2400 so as to enable to rotate in the second direction.

The guide rail 2500 is structured in such a manner that the slider block 2400 is inserted into the guide rail so as to be movable in the first direction along the guide rail 2500.

In addition, the second body 2200 and the first body 2100 is configured such that the slider block 2400 can be turned in the second direction about the hinge portion 2300 only when the guide rail 2500 is moved up along the slider block 2400 until the open state.

On the other hand, the guide rail 2500 is provided with a guide rod 2510 disposed along the traveling direction of the second body 2200, and the slider block 2400 is formed with a slide hole 2412 with which the guide rod 2510 is slidably combined.

At least one ball 2430 is installed in the contact area between the slider block 2400 and the guide rail 2500 to move the second body 2200 against the first body 2100 in a stable way with a reduced frictional force in-between.

For this purpose, the slider block 2400 is provided with one or more ball holders 2414 formed such that the respective balls 2430 is rotatably inserted and partially protrudes towards the guide rail 2500. In addition, the slider block 2400 is provided with one or more leaf springs 2440 for forcing the ball 2430 towards the guide rail 2500.

Further, the slider block 2400 may be divided into a first case 2410 and a second case 2420 in order to facilitate combination of the leaf spring 2440 and the ball 2430.

In addition, formed in both end portions of the guide rail 2500 is a protrusion 2520 formed to have a desired height, so that the ball 2430 can be pushed to the end portion of the guide rail.

A damper 2530 is installed in both ends of the guide rail 2500 in order to reduce impact with the slider block 2400. The damper 2530 may be formed of high-elastic synthetic resin materials such as silicon, urethane, rubber or the like.

On the other hand, the hinge portion 2300 includes a housing 2310 to be fixed to the first body 2100 and a connection shaft 2320 installed turnable in the second direction and to be coupled to the slider block 2400.

The connection shaft 2320 is formed in a non-circular shape. The slider block 2400 is formed with a shaft hole 2416 through which the connection shaft 2320 is combined with the slider block 2400.

In addition, the hinge portion 2300 includes a clutch means for holding the connection shaft 2320 at the non-rotated position or at the rotated position in the second direction by certain angles.

The clutch means is composed of a first cam 2330, a second cam 2340 and a second resilient member. The first cam 2330 is formed integrally with the connection shaft 2320 and rotatably inserted into the housing 2310. A first waveform face 2332 composed of a ridge and a valley is provided in the first cam 1330. The second cam 2340 is provided with a second waveform face 2342 formed so as to correspond to the first waveform face 2332. The second cam 2340 is inserted into the housing 2310 such that the second waveform face 2342 faces the first waveform face 2332. Further, the second cam 2340 is formed so as to perform a linear motion towards the first cam 2330, but not to rotate inside the housing 2310. The resilient member is configured to exert an elastic force such that the first and second waveform faces 2332 and 2342 are forcibly biased towards each other. The resilient member may be formed of a compression spring 2350.

In addition, the ridge portion in the second waveform face 2342 of the second cam 2340 is formed of a flat face 2344 to enable a free-stop.

Details on this clutch means are disclosed in Korean Patent Application No. 2001-18902 entitled “A cover hinge device of portable phones.”

On the other hand, the communications terminal of this embodiment is provided with a flexible PCB 2110 electrically connecting the first body 2100 and the second body 220 with each other. The flexible PCB 2110 has a length enough to move the second body 2200 in the first direction. The first body 2100 includes a guide 2120 for guiding the flexible PCB 2110 so as to be bent in a direction perpendicular to the first direction.

Hereafter, operation of the above-configured slide-up opening and closing apparatus will be explained.

FIG. 28 is a perspective view of the communications terminal of third embodiment where the second body 2200 is closed. FIG. 29 is a perspective view of the opening and closing apparatus when the communications terminal is in the state of FIG. 28.

When the second body 2200 is closed on the first body 2100, the first cam 2300 and the second cam 2340 are interlocked with each other by the resiliency of the compression spring 2350 to inhibit the second body 2200 from turning in the second direction.

Further, the ball 2430 installed in the slider block 2400 is latched into the protrusion 2520 of the guide rail 2500, so that the second body 2200 is inhibited from moving in the first direction.

First, the case where the second body 2200 is opened in the first direction from the first body 2100 in parallel with each other will be explained.

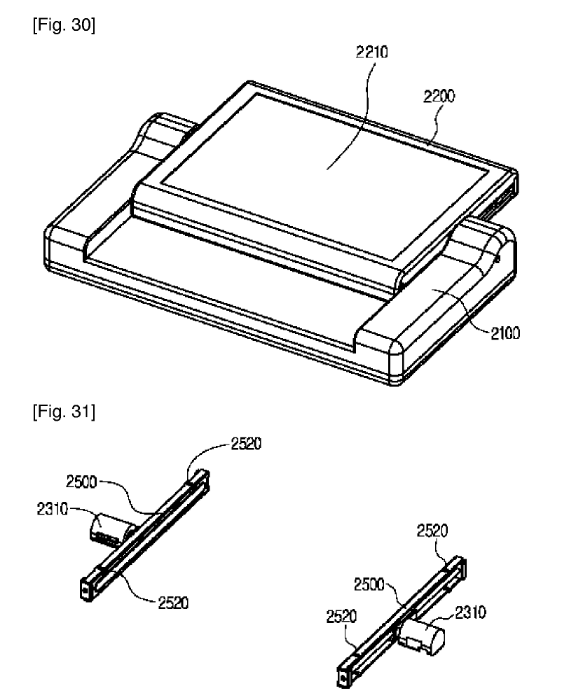

FIG. 30 is a perspective view of the terminal of FIG. 28 where the second body 2200 is partially opened in the first direction. FIG. 31 is a perspective view of the opening and closing apparatus when the terminal is in the state of FIG. 30.

If the second body 2200 is pushed in the first direction, the guide rod 2510 fixed to the guide rail 2500, which is fixed to the second body 2200, moves on the slider hole 2412 of the slider block 2400, which is fixed to the first body 2100.

At the initial state, the protrusion 2520 of the guide rail 2500 pushes the ball 2430 installed in the slider block 2400, and the ball 2430 pushes the leaf spring 2440 to provide a space for the protrusion 2520 to move. During the movement of the guide rail 2500, the ball 2430 contacts with and rolls on the guide rail. Thus, the slider block 2400 and the guide rail 2500 are prevented from contacting each other to thereby minimize friction and thus perform a stable and smooth travel.

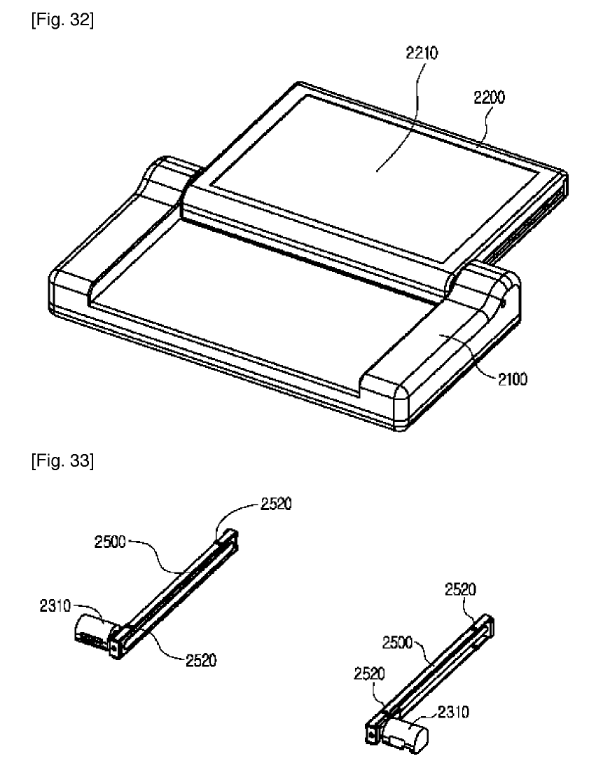

FIG. 32 is a perspective view of the communications terminal of FIG. 30 where the second body 2200 is completely opened in the first direction. FIG. 33 is a perspective view of the opening and closing apparatus when the terminal is in the state of FIG. 32.

As shown in the figures, when the guide rail 2500 moves up to the end along the slider block 2400, the slider block 2400 contacts the damper 2530 and stops, and the ball 2430 goes beyond the protrusion 2520 and stops with a desired retaining force. In this way, the opening of the guide rail 2500 and the second body 2200 in the first direction is completed.

During the above opening of the second body 2200 in the first direction, the flexible PCB electrically connecting the first and second bodies 2100 and 2200 with each other is bent in a direction perpendicular to the first direction along the guide 2120 formed in the first body, thereby not interfering with the movement of the second body 2200.

As described above, when the second body 2200 is opened simply in the first direction, the keypad of the first body 2100 is exposed, thereby allowing use of the inherent functions of the communications terminal.

Closing of the second body 2200 in the first direction can be performed in reverse orders to the above operations.

On the other hand, at the state where the second body 2200 is opened in the first direction, the liquid crystal window 2210 of the second body 2200 can be seen at more convenient angle as follows.

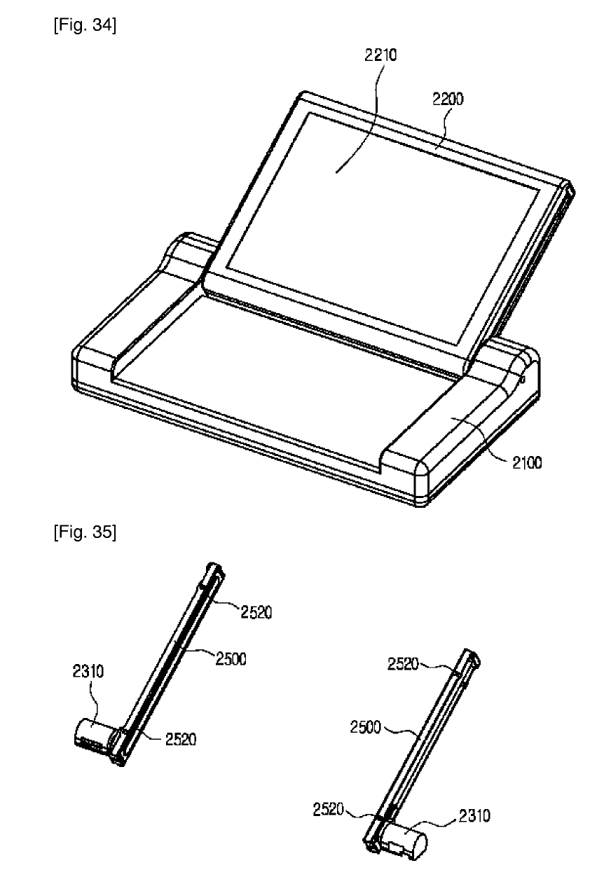

FIG. 34 is a perspective view of the communications terminal where the second body 2200 is partially turned or rotated in the second direction, and FIG. 35 show the opening and closing apparatus when the terminal is in the state of FIG. 34.

If one edge portion of the second body 2200 is pulled up, the second body 2200 rotates about the connection shaft 2320 and turns in the second direction.

At the initial state, the rotation of the second body 2200 is resisted while the ridge of the first waveform face 2332 formed in the first cam 2330 is being released from the valley of the second waveform face 2342 formed in the second cam 2340. However, when the ridge of the first cam 2330 reaches the flat face 2344 of the second cam 2340, i.e., the free-stop region, inclination angle of the second body 2200 can be freely adjusted.

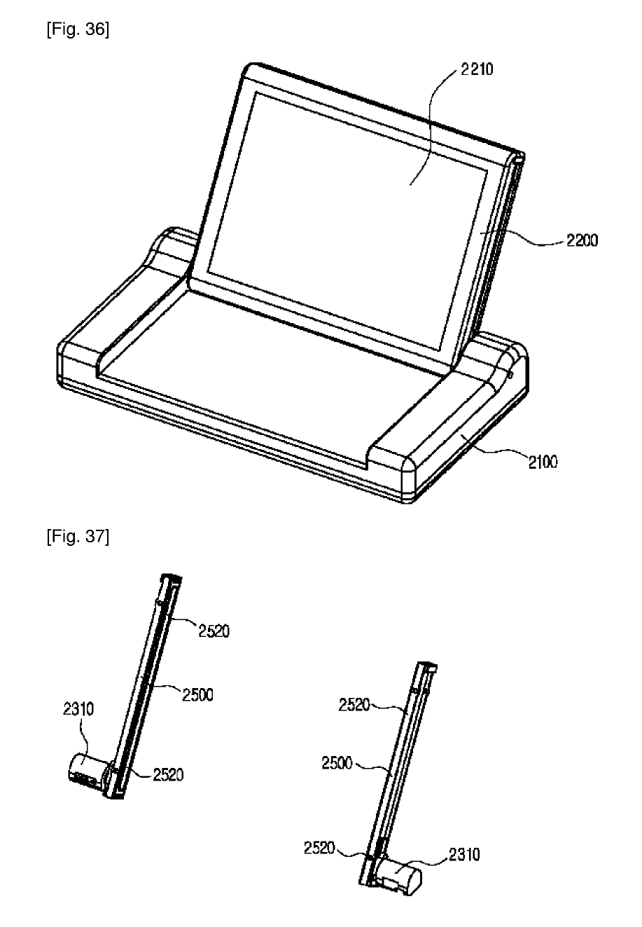

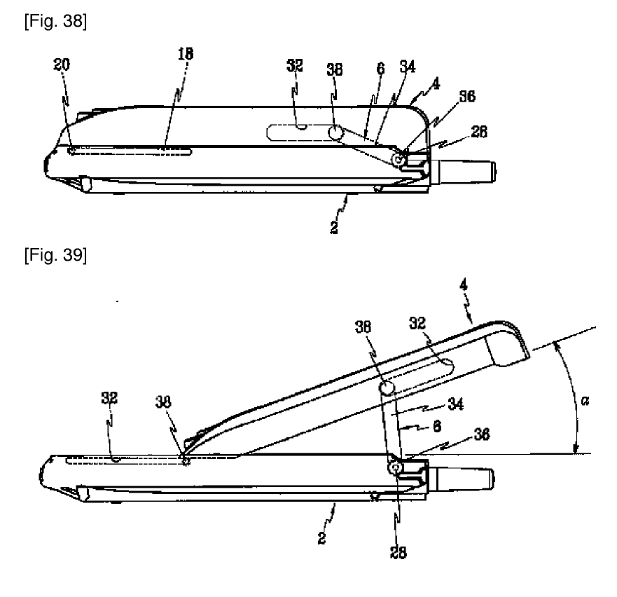

FIG. 36 is a perspective view of the communications terminal of FIG. 34 where the second body 2200 is completely rotated in the second direction. FIG. 37 is a perspective view of the opening and closing apparatus when the terminal is in the state of FIG. 36.

As shown in the figures, if the second body 2200 continues to turn in the second direction, the ridge of the first waveform face 2332 goes beyond over the ridge of the second waveform face 2342. Then, the connection shaft 2320 is rotated in the opening direction and thus automatic rotation of the second body 2200 occurs.

In this way, when the second body 2200 is turned enough in the second direction, again the ridge and valley of the first waveform face 2332 formed in the first cam 2330 is engaged with the ridge and valley of the second waveform face 2342 formed in the second cam 2340, thereby incurring a desired retaining force. Thus, the second body 2200 can remain rotated in the second direction.

In this way, during the rotation of the second body in the second direction, the flexible PCB 2110 electrically connecting the first and second bodies 2100 and 2200 to each other comes to bend at the same angle as the connection shaft 2320.

As described above, if the second body 2200 is turned in the second direction, the second body 2200 and the first body 2100 forms an angle convenient and suitable for a user to look at the terminal and to carry out communications using the terminal.

Returning the second body 2200 to the initial position along the second direction can be done in reverse orders of the above operations.

### INDUSTRIAL APPLICABILITY

As described above, the slide-up opening and closing apparatus according to the invention can be applied to communications terminals such as portable terminals and computers that are composed of separate slider body and main body and thus needs opening and closing operations. The slider body can be opened with a desired inclination with respect to the main body and, after a certain degree of opening, automatically opened without a further action.

Although the present invention has been described with reference to several exemplary embodiments, the description is illustrative of the invention and is not to be construed as limiting the invention. Various modifications and variations may occur to those skilled in the art, without departing from the spirit and scope of the invention, as defined by the appended claims.

1. A slide-up opening and closing apparatus for a communications terminal, the communications terminal including a main body and a slider body slidably coupled with the main body, the apparatus comprising:
a pair of slider units disposed in the main body;
a slider assembly disposed between the main body and the slider body, the slider assembly moving along the pair of slider units such that the slider body is opened against the main body;
an angular positioning member having a pivot rotatably coupled to the main body and a rotor tip coupled to the slider body, the rotor tip being turned about the pivot such that the slider body is opened in an inclined fashion;
a click cam shaft fixed to the pivot of the angular positioning member, the angular positioning member having a protruded portion on the outer circumferential face thereof; and
a resilient member configured such that at one point during rotation of the click cam shaft, the resilient member is substantially maximally compressed by the protruded portion of the click cam shaft and then exerts the elastic restoring force on the click cam shaft to guide the click cam shaft to rotate in any one direction.

2. The apparatus as claimed in claim 1, wherein the slider assembly includes: a slider disposed so as to move along the pair of slider units; and a slider housing installed at one end of the slider body so as to be rotatable and movable up and down with respect to the slider.

3. The apparatus as claimed in claim 2, wherein the slider housing is assembled into the slider by means of a fixing pin being inserted into an elongated hole in the slider.

4. The apparatus as claimed in claim 1, wherein the slider is provided with a bracket fixed to both lateral sides of the central portion thereof, a fixed shaft is coupled to the bracket, and the rotor tip of the angular positioning member is rotatably assembled into the fixed shaft.

5. The apparatus as claimed in claim 1, wherein the main body has a slide groove on top thereof for facilitating movement of the slider assembly.

6. The apparatus as claimed in claim 1, wherein the pivot of the angular positioning member is disposed rearwards of the slider assembly along the opening direction of the slider body.

7. The apparatus as claimed in claim 1, wherein the click cam shaft is rotatably installed in a cam receptacle disposed in one end of at least one of the slider units, the resilient member is disposed inside of the cam receptacle, and a holder is disposed between the click cam shaft and the resilient member.

8. A slide-up opening and closing apparatus for a communications terminal, the communications terminal including a main body and a slider body slidably coupled with the main body, the apparatus comprising:
a pair of slider units disposed in the main body;
a slider assembly disposed between the main body and the slider body, the slider assembly moving along the pair of sider units such that the slider body is opened against the main body;
an angular positioning member having a hinge portion rotatably coupled to the main body and a rotor tip coupled to the slider body, the rotor tip being turned about the hinge portion such that the slider body is opened in an inclined fashion;
a shaft cam for rotatably coupling the hinge portion of the angular positioning member with the main body;
a holder cam moving far away from and engaging again with the shaft cam along the axial direction while rotating with the hinge portion of the angular positioning member; and
a resilient member configured such that when the holder cam moves away from the shaft cam, the resilient member is compressed and then exerts the elastic restoring force on the holder cam to guide the holder cam to rotate in any one direction.

9. The apparatus as claimed in claim 9, wherein the slider assembly includes:
a slider disposed so as to move along pair of sider units;
a slider arm rotatably connected to the slider; and
a slider housing installed at one end of the slider body so as to be rotatable and movable up and down with respect to the slider arm.

10. The apparatus as claimed in claim 9, wherein the slider assembly further includes a torsion spring inserted between the slider arm and the slider such that the angle between the slider arm and the slider is maintained constant so that the end portion of the slider arm assembled to the slider housing can be placed close to the main body.

11. The apparatus as claimed in claim 9, wherein the slider housing has a protrusion inserted into an elongated hole in the slider arm.

12. The apparatus as claimed in claim 8, wherein the slider includes a bracket fixed to both lateral sides of the central portion thereof, wherein a fixing shaft is coupled to the bracket, and wherein the rotor tip of the angular positioning member is rotatably assembled into the fixing shaft.

13. The apparatus as claimed in claim 8, wherein the main body has a slide groove on top thereof for facilitating movement of the slider assembly.

14. The apparatus as claimed in claim 8, wherein the hinge portion of the angular positioning member is disposed rearwards of the slider assembly along an opening direction of the slider body.

15. The apparatus as claimed in claim 8, wherein the shaft cam has a waveform face having two periods per rotation, and the holder cam has a waveform face corresponding to the waveform face of the shaft cam.

16. The apparatus as claimed in claim 8, wherein a hinge cover is coupled with the hinge portion of the angular positioning member, the hinge cover preventing the shaft cam, the holder cam, and the resilient member from being escaped.

17. A slide-up opening and closing apparatus for a communications terminal having a first body and a second body, the apparatus comprising:
a guide rail being fixed to the second body;
a slider block guiding the guide rail so as to slidably move in a first direction;
one or more balls installed in a contact area between the slider block and the guide rail to reduce friction there between; and
a hinge portion being fixed to the first body and coupled to the slider block so as to enable turning in a second direction, wherein the second body can be slidably opened in a first direction from the first body in parallel to each other and one end of the second body can be lifted up from the first body to turn in the second direction.

18. The apparatus as claimed in claim 17, wherein the slider block is configured to turn in the second direction about the hinge portion only when the guide rail is moved up along the slider block to an opening position.

19. The apparatus as claimed in claim 17, wherein the guide rail includes a guide rod disposed along a traveling direction of the second body, and the slider block includes a slide hole formed such that the guide rod is slidably engaged with the slide hole.

20. The apparatus as claimed in claim 17, wherein the slider block includes one or more ball holders into which the respective ball is rotatably inserted and partially protrudes towards the guide rail, and one or more first resilient members installed so as to push the ball towards the guide rail.

21. The apparatus as claimed in claim 20, wherein the first resilient member comprises a leaf spring.

22. The apparatus as claimed in claim 17, wherein a protrusion having a desired height is formed at both edge areas of the guide rail, the protrusion pushing the ball to the end portion of the edge.

23. The apparatus as claimed in claim 17, wherein the guide rail includes a damper at both edges thereof for mitigating impact with the slider block.
